(19) United States
(12) Patent Application Publication
(10) Pub. No.: US 2017/0138154 A1
(43) Pub. Date: May 18, 2017

(54) Wireless Control Valve

(71) Applicant: Woodward, Inc., Fort Collins, CO (US)

(72) Inventors: Wade Burdick, Windsor, CO (US); Kevin E. Greeb, Fort Collins, CO (US); Kevin Finnan, Goshen, CT (US); Brian Hahn, Fort Collins, CO (US); Shawn A. Miks, Fort Collins, CO (US); John Williams, JR., Fort Collins, CO (US)

(21) Appl. No.: 15/355,636

(22) Filed: Nov. 18, 2016

Related U.S. Application Data
(60) Provisional application No. 62/257,018, filed on Nov. 18, 2015.

(51) Int. Cl. E21B 34/16; G05D 7/06; F16K 31/04; E21B 34/02; E21B 47/06

(52) U.S. Cl. CPC E21B 34/16; E21B 34/02; E21B 47/06; E21B 47/065; F16K 31/047; G05D 7/0635; F16K 31/046

(57) ABSTRACT

The subject matter of this specification can be embodied in, among other things, a process control valve including a fluid valve body having an inlet for receiving fluid, an outlet for discharging fluid, a fluid flow passage connecting the inlet and outlet, and a controllable throttling element which is moveable to selectively vary the cross-sectional area of flow of at least a portion of the passage, a valve actuator coupled to the valve body and responsive to control signals, a sensor for producing at least one signal representative of at least one of absolute pressure, gage pressure, differential pressure, flow, and temperature within the fluid flow passage, a communication system for receiving configuration information and transmitting status information, and a controller comprising a processor for receiving said signal and configuration information, for developing an output dependent upon the configuration information and the received signal, and for developing the status information.

### CROSS REFERENCE TO RELATED APPLICATIONS

This application has a common inventor with U.S. patent application Ser. No. 10/340,017, filed Jan. 10, 2003 and entitled “ACTUATOR FOR WELL-HEAD VALVE OR OTHER SIMILAR APPLICATIONS AND SYSTEM INCORPORATING SAME”, issued Oct. 11, 2005 as U.S. Pat. No. 6,953,084, the disclosure of which is incorporated by reference in its entirety. This application is also related to and claims the priority benefit of U.S. Provisional Application No. 62/257,018, which is incorporated herein by reference in its entirety.

### TECHNICAL FIELD

This specification relates to integrated process control valves having a wireless control subsystem capable of controlling the flow of a fluid through the valve and of monitoring various parameters of the fluid.

### BACKGROUND

In the commercial natural gas production industry, a network of gas collection pipes often will connect and branch together tens to hundreds of natural gas ground wells in a localized geographic region. The individual wells will feed natural gas through the network of gas collection pipes to a common output location. The wells may be owned by several different land owners and/or mineral rights owners who may sell their natural gas production to a commercial supplier of natural gas. The commercial supplier will typically purchase natural gas from the land or rights owners based upon its needs. This provides a need for regulating and monitoring natural gas production from each well. Even if the commercial purchaser of natural gas owns the land or the mineral rights, it will still want to monitor and/or regulate the production of each well to control its supply. Often, the desired natural gas output is less than the maximum production capacity of the several wells combined. Such demands can change due to cyclical seasonal trends and for other economic reasons.

To regulate the production output of each individual well, the branch collection pipe for each individual well typically has a flow regulating valve and a gas flow sensor arranged in fluid series. The gas flow sensor indicates the amount of natural gas that flows through the collection pipe. The regulating control valve provides a variable degree of opening that forms a restriction orifice in the collection pipe and thereby sets the natural gas flow rate in the collection pipe.

### SUMMARY

In general, this document describes integrated process control valves having a wireless control subsystem capable of controlling the flow of a fluid through the valve and of monitoring various parameters of the fluid.

In a first aspect, a process control valve includes a fluid valve body having an inlet for receiving fluid, an outlet for discharging fluid, a fluid flow passage connecting the inlet and outlet, and a controllable throttling element which is moveable to selectively vary the cross-sectional area of flow of at least a portion of the passage, a valve actuator coupled to the valve body and responsive to control signals for selectively moving the throttling element, a sensor for producing at least one signal representative of at least one of absolute pressure, gage pressure, differential pressure, flow, and temperature within the fluid flow passage, a communication system for receiving configuration information and transmitting status information, and a controller comprising a processor for receiving said signal and configuration information, for developing an output dependent upon the configuration information and the received signal, and for developing the status information.

Various embodiments can include some, all, or none of the following features. The sensor can include a first pressure sensor disposed at the inlet of the valve body for producing a first signal representing the pressure of the fluid at the inlet, a second pressure sensor disposed at the outlet of the valve body for producing a second signal representing the pressure of the fluid at the outlet, a receiver for receiving said first and second signals and for developing an output dependent upon the received signals, and said controller can be configured to determine the fluid pressure drop across the valve body from the first and second signals, store a predetermined fluid pressure drop value, compare the determined fluid pressure drop with the stored fluid pressure drop value and for producing a difference signal whose magnitude represents a difference between the compared values, and determine control signals for application to the actuator to cause it to move the throttling element to thereby vary the fluid pressure drop across the valve body to more closely match the stored fluid pressure drop value and reduce the magnitude of the difference signal. The controller can include a processor for storing a predetermined temperature value, comparing the signal representing the temperature T1 of the fluid with the stored temperature value and for producing a difference signal whose magnitude represents the difference between the compared values, producing control signals for application to the actuator to cause it to move the throttling element to thereby vary the temperature of fluid flowing in the passage to more closely match the stored temperature value and reduce the magnitude of the difference signal. The process control valve can also include a temperature sensor for producing a temperature signal representing the temperature of the fluid in the fluid flow passage, and a throttling element position sensor for producing a flow signal representing the flow capacity of the valve body, and wherein said controller can be configured to determine the flow rate of the fluid in the passage from the signal, the temperature signal, and the flow signal. The processor can be adapted for storing a predetermined flow rate value, comparing the determined flow rate with the stored flow rate value and for producing a difference signal whose magnitude represents the difference between the compared values, and producing control signals for application to the actuator to cause it to move the throttling element to thereby vary the flow rate to more closely match the stored flow rate value and reduce the magnitude of the difference signal. The process control valve can also include a power system for powering one or more of said valve actuator, said sensor, said communication system, and said controller, wherein the instantaneous power drawn from said power system does not exceed 3 Watts. The process control valve can include an enclosure configured to protect said valve actuator, said sensor, said communication system, and said controller in hazardous locations requiring Class I, Division 1 rated equipment. The processor can be configured for receiving program instructions operable to perform control functions comprising one or more of pressure regulation, flow control, level control, and plunger lift control. The status information can include one or more of a predicted time of malfunction, an identity of a part, an identity of a preventative or remedial service, and a schedule identifying a period of reduced functionality until service or maintenance can be provided. The configuration information can include one or more of a flow set point, a temperature set point, a pressure set point, a confirmation of reduced functionality, a planned maintenance time, and a request for additional data. The communication system can include a wireless transceiver for receiving configuration information and transmitting status information wirelessly. The communications system can include a wired transceiver for receiving configuration information and transmitting status information over a wired connection.

In another aspect, a method for controlling a process flow includes providing a process control valve including a fluid valve body having an inlet for receiving fluid, an outlet for discharging fluid, a fluid flow passage connecting the inlet and outlet, and a controllable throttling element which is moveable to selectively vary the cross-sectional area of flow of at least a portion of the passage, a valve actuator coupled to the valve body and responsive to control signals for selectively moving the throttling element, a controller integrated with the process control valve and comprising a processor for receiving said signal and configuration information, for developing an output dependent upon the configuration information and the received signal, and for developing the status information, receiving, by a communication system integrated with the process control valve, a collection of configuration information, sensing, by a sensor integrated with the process control valve, at least one of absolute pressure, gage pressure, differential pressure, flow, and temperature within the fluid flow passage as a sensor signal, determining, by a processor associated with a controller integrated with the process control valve and based on said signal and configuration information, an output based on the configuration information, actuating, by the valve actuator and based on the output, movement of the controllable throttling element to selectively vary the cross-sectional area of flow of at least a portion of the passage, determining, by said processor and based on said sensor signal and said configuration information, a collection of status information, and transmitting, by the communication system, the status information.

Various implementations can include some, all, or none of the following features. The sensor signal can include a first pressure signal based on a first pressure sensor disposed at the inlet of the valve body and representing the pressure of the fluid at the inlet, a second pressure signal based on a second pressure sensor disposed at the outlet of the valve body and representing the pressure of the fluid at the outlet, wherein the method further includes receiving said first pressure signal and said pressure signal and for developing an output dependent upon the received signals, determining, by the controller, a fluid pressure drop across the valve body based on the first pressure signal and second pressure signal, storing, by the controller, a predetermined fluid pressure drop value, comparing, by the controller, a determined fluid pressure drop with the stored fluid pressure drop value, determining, by the controller, a difference signal whose magnitude represents a difference between the compared values, and moving, by the valve actuator, the throttling element to vary the fluid pressure drop across the valve body to more closely match the stored fluid pressure drop value. The method can also include storing, by the controller, a predetermined temperature value, comparing, by the controller, a temperature signal representing the temperature of the fluid with a stored temperature value, determining, by the controller, a difference signal whose magnitude represents the difference between the compared values, moving, by the valve actuator, the throttling element to thereby vary the temperature of fluid flowing in the passage to more closely match the stored temperature value. The method can include determining, by the controller and based on a temperature signal representing the temperature of the fluid in the fluid flow passage, determining, by the controller and based on a throttling element position sensor, a flow signal representing the flow capacity of the valve body, and determining, by the controller, a flow rate of the fluid in the passage based on the sensor signal, the temperature signal, and the flow signal. The method can include storing, by the controller, a predetermined flow rate value, comparing, by the controller, a determined flow rate with the stored flow rate value, determining, by the controller, a difference signal whose magnitude represents the difference between the compared values, and providing, by the controller, control signals for application to the actuator to cause the actuator to move the throttling element to vary the flow rate to more closely match the stored flow rate value. The method can include receiving, by the controller, program instructions operable to perform control functions comprising pressure regulation, flow control, level control, and plunger lift control. The status information can include one or more of a predicted time of malfunction, an identity of a part, an identity of a preventative or remedial service, and a schedule identifying a period of reduced functionality until service or maintenance can be provided. The configuration information can include one or more of a flow set point, a temperature set point, a pressure set point, a confirmation of reduced functionality, a planned maintenance time, and a request for additional data. The communication system can be a wireless transceiver, wherein receiving, by the communication system integrated with the process control valve, the collection of configuration information includes receiving, by the wireless transceiver, the collection of configuration information wirelessly, and transmitting, by the communication system, the status information includes transmitting, by the wireless transceiver, the status information wirelessly. The communication system can include a wired transceiver, wherein receiving, by the communication system integrated with the process control valve, the collection of configuration information includes receiving, by the wired transceiver, the collection of configuration information over a wired connection, and transmitting, by the communication system, the status information includes transmitting, by the wired transceiver, the status information over a wired connection.

In another aspect, an electrically actuated valve includes an electric motor adapted to rotate an output shaft, a gear reduction train having a plurality of gears including an input gear driven by the output shaft and a rotary output, the plurality of gears adapted to amplify force from the input gear to the rotary output when the electric motor rotates the output shaft, a valve adapted to control fluid flow therethrough, the valve including a valve housing and a valve member, the valve housing defining a flow passage, the valve member movable in the valve housing between open and closed positions to control a degree of opening of the flow passage, a spring arranged to urge the valve to one of the open and closed positions, the brake when in the on position providing sufficient resistance to hold a current position of the valve against the action of the spring, and wherein the electric motor has a sufficient rotary output force to overcome resistance of the brake when in the on position to move the valve, a sensor for producing at least one signal representative of at least one of absolute pressure, gage pressure, differential pressure, flow, and temperature within the fluid flow passage, a communication system for receiving configuration information and transmitting status information, and a controller comprising a processor configured to receive said signal and configuration information, determine an output dependent upon the configuration information and the received signal, and determine the status information.

Various embodiments can include some, all, or none of the following features. The sensor can include a first pressure sensor disposed at the inlet of the valve body for producing a first signal representing the pressure of the fluid at the inlet, a second pressure sensor disposed at the outlet of the valve body for producing a second signal representing the pressure of the fluid at the outlet, a receiver for receiving said first and second signals and for developing an output dependent upon the received signals, and said controller is configured to determine a fluid pressure drop across the valve body from the first and second signals, store a predetermined fluid pressure drop value, compare the determined fluid pressure drop with the stored fluid pressure drop value and for producing a difference signal whose magnitude represents a difference between the compared values, and produce control signals for application to the actuator to cause it move the throttling element to thereby vary the fluid pressure drop across the valve body to more closely match the stored fluid pressure drop value and reduce the magnitude of the difference signal. The controller can be further configured to store a predetermined temperature value, compare the signal representing the temperature of the fluid with the stored temperature value and for producing a difference signal whose magnitude represents the difference between the compared values, produce control signals for application to the actuator to cause it to move the throttling element to thereby vary the temperature of fluid flowing in the passage to more closely match the stored temperature value and reduce the magnitude of the difference signal. The electrically actuated valve can also include a temperature sensor for producing a temperature signal representing the temperature of the fluid in the fluid flow passage, and a throttling element position sensor for producing a flow signal representing the flow capacity of the valve body, and wherein said controller can be configured to determine the flow rate of the fluid in the passage from the signal, the temperature signal, and the flow signal. The processor can be configured to store a predetermined flow rate value, compare the determined flow rate with the stored flow rate value and for producing a difference signal whose magnitude represents the difference between the compared values, and produce control signals for application to the actuator to cause it to move the throttling element to thereby vary the flow rate to more closely match the stored flow rate value and reduce the magnitude of the difference signal. The electrically actuated valve can also include a power system for powering one or more of said valve actuator, said sensor, said communication system, and said controller, wherein the instantaneous power drawn from said power system does not exceed 3 Watts. The electrically actuated valve can also include an enclosure configured to protect said valve actuator, said sensor, said communication system, and said controller in hazardous locations requiring Class I, Division 1 rated equipment. The processor can be configured to receive program instructions operable to perform control functions comprising one or more of pressure regulation, flow control, level control, and plunger lift control. The status information can include one or more of a predicted time of malfunction, an identity of a part, an identity of a preventative or remedial service, and a schedule identifying a period of reduced functionality until service or maintenance can be provided. The communication system can include a wireless transceiver for receiving configuration information and transmitting status information wirelessly. The communications system can include a wired transceiver for receiving configuration information and transmitting status information over a wired connection.

The systems and techniques described here may provide one or more of the following advantages. First, a system can provide local process control which provides the ability to manage gas and oil production in accordance with current economic situations dynamically and from remote central locations. Second, the system can be used to automate upstream oil and gas processes that are not fully automated. Third, the system can provide improved functionality over valve controls using pneumatic actuators, separate sensors, and separate control units. Fourth, the system can reduce installation and commissioning time. Fifth, the system can reduce emissions and wasted resources generally associated with the bleeding of gas by pneumatic actuators every time the position demand changes.

The details of one or more implementations are set forth in the accompanying drawings and the description below. Other features and advantages will be apparent from the description and drawings, and from the claims.

### DESCRIPTION OF DRAWINGS

FIG. 1 is a schematic plan view of an example well-head system incorporating an example electrically actuated valve.

FIG. 2 is an isometric view of the example electrically actuated.

FIGS. 3-4 are cross sections of the example electrically actuated valve with the cross sectional views being shown from the front and the side.

FIGS. 5 and 6 are cross sections of the example electrical actuator.

FIG. 7 is a cross section of the example electrical actuator.

FIG. 8 is an enlarged cross section of the example valve portion of the example electrically actuated valve.

FIG. 9 illustrates an example sealing arrangement for the example valve.

FIG. 10 is an exploded assembly view of the example sealing arrangement.

FIG. 11 is an isometric view of the internal components of the example electrical actuator.

FIG. 12 is a side view of the internal components of the example electrical.

FIGS. 13-14 are frontal and back views of the internal components of the example electrical actuator.

FIG. 15 is a block diagram of an example natural gas well production system.

FIG. 16 is another block diagram of an example electrically actuated valve and the example integrated valve control module.

FIGS. 17A-17B are partial cutaway views of an example electrically actuated valve and integrated valve control module.

FIG. 18 is a flow diagram of an example process for operating an example electrically actuator valve with integrated control module.

### DETAILED DESCRIPTION

This document describes systems and techniques for remote control of fluid valve actuators. In general, an electrical actuator valve can include control, power, communications, and sensing subsystems to enable remote operations personnel to configure, monitor, and receive status information to/from fluid valves that may be located remotely from the operations personnel, power infrastructure, and/or communications infrastructure.

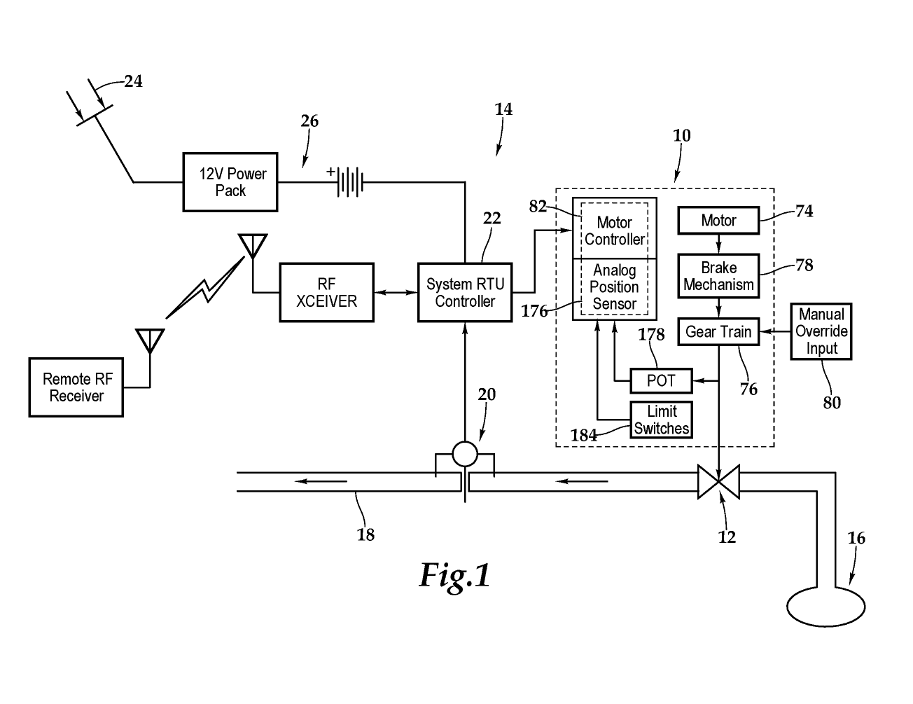

FIG. 1 illustrates an example natural gas well production system 14 which is an exemplary application and operational environment for an example electrical actuator 10. The well-head valve 12 regulates the production output of a natural gas production well 16 through a collection pipe 18. The well-head valve 12 is mounted in the collection pipe 18 in fluid series with a gas flow sensor 20. The degree of opening of the well-head valve 12 and the natural gas pressure of the well 16 (which typically ranges between about 10-900 psi or even higher for most production wells) determine the natural gas flow rate through the collection pipe 18. The gas flow sensor 20 measures the amount of natural gas that flows through the pipe 18. The gas flow sensor 20 provides electrical feedback representative of the sensed flow rate to an electronic controller 22 for closed loop control over the electrical actuator 10 and well-head valve 12.

Since the well 16 may be located remote from a commercially available electrical power supply, the system 14 is shown to include a local electrical power supply which typically comprises a small solar panel 24 and battery 26. The solar panel 24 generates a small electrical power supply and the battery 26 stores the electrical power supply. Advantageously, the electrical actuator 10 can replace pneumatic actuation systems without needing any additional power or electrical generation, using only the existing local electrical power supply, if desired. As such, additional cost need not be wasted on electrical generation, and the present invention may be employed as a retrofit device to replace pneumatic actuating systems at existing well-head valves. In some embodiments, additional expansion of the electrical generation or storage capabilities may be included.

In FIG. 1, two separate controllers 22, 82 are indicated, but these may be integrated if desired into a single controller assembly. In some embodiments, two separate controllers 22, 82 may be used to provide for both retrofit and new systems.

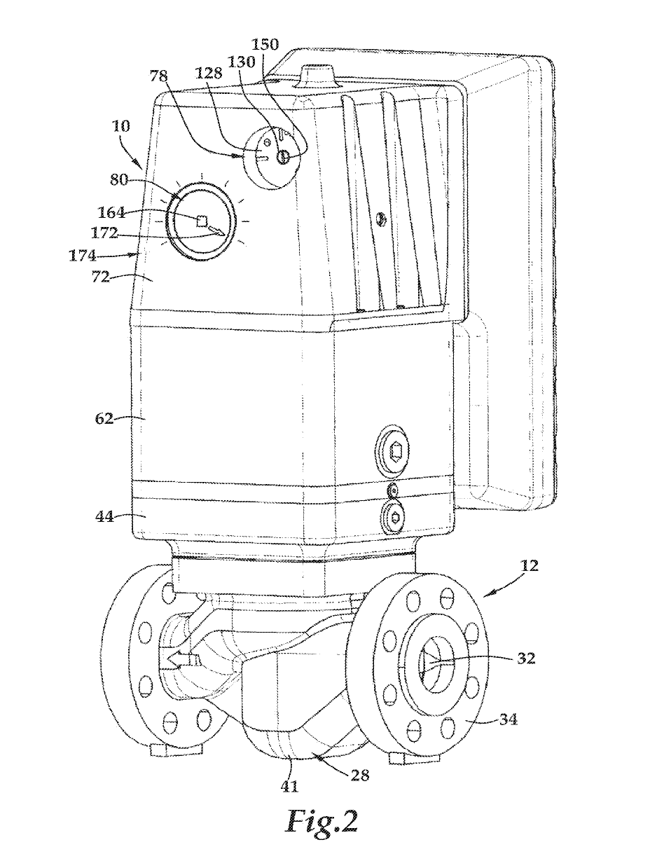

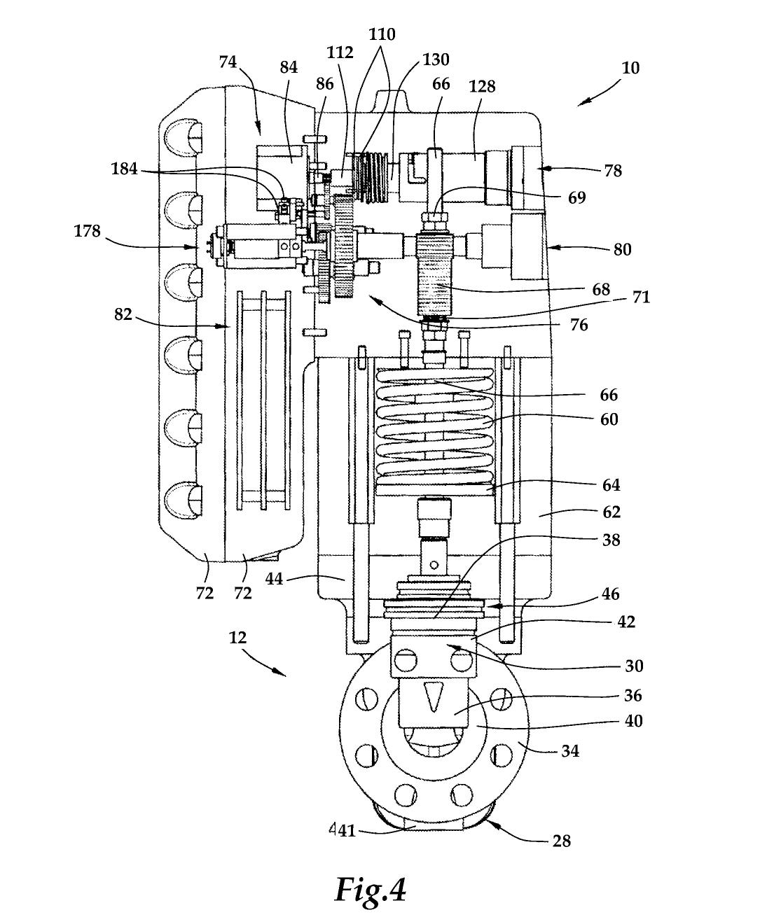

The well-head valve 12 may be a linearly translatable valve, a rotary valve or other movable/positionable valve. Referring to FIGS. 2-4 and 8, the illustrated well-head valve 12 is shown as the linear type comprising a valve housing 28 and linearly translatable valve member 20. The valve housing 28 includes a valve body 41 defining a flow passage 32. The flow passage 32 extends between and through a pair mounting flanges 32 on ends of the valve body 41. The mounting flanges 32 are adapted to mount the well-head valve 12 on a collection pipe 18. The valve member 20 may include separate components including a plug member 36 and an elongate valve stem 38 extending from the plug member 38, as is shown. The valve stem 38 extends through the valve housing 20 and is acted upon by the electrical actuator 10. The valve stem 38 transmits the selective positioning force from the electrical actuator 10 to the plug member 36. The plug member 36 is situated in cage 42 along the flow passage 32 to provide a restriction orifice that regulates flow through the valve. The plug member 36 is linearly translatable toward and away from a valve seat 40 between fully closed and fully open positions, and intermediate positions therebetween. The plug member 36 blocks all flow when in the fully closed position and allows for maximum flow when in the fully open position.

To provide for installation of the movable valve member 20, the valve housing 38 may be composed of multiple pieces including the valve body 41, a metering cage 42 which radially restrains and guides movement of the valve plug member 36 and a bonnet 44 which radially restrains and provides for a seal arrangement 46. The seal arrangement 46 provides a static seal and dynamic seal that prevents leakage of natural gas from the valve 12. One suitable seal arrangement for preventing natural gas leakage in the valve is illustrated in U.S. Pat. No. 6,161,835 to Don Arbuckle, the entire disclosure of which is incorporated by reference.

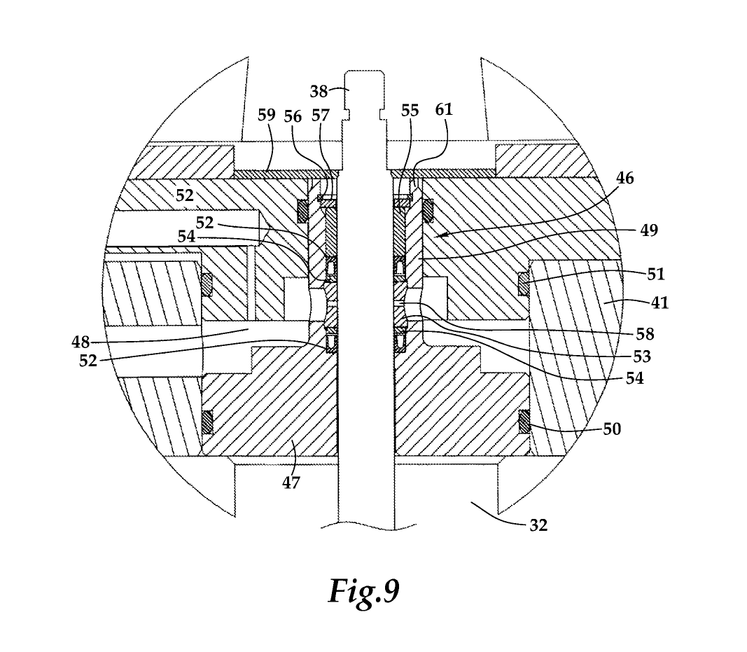

Referring to FIGS. 9-10, the sealing arrangement 46 includes a pressuring annular piston 47 extending through and surrounding the valve stem 38. One face of the piston 47 is acted upon by process fluid contained in the valve flow passage 32 to pressurize seal lubricant fluid that is contained in a sealant cavity 48. The piston 47 includes a sleeve portion 49 that contains a seal packing. The outer periphery of the piston 47 carries an O-ring seal 50 for preventing communication between process fluid and lubricant. Not much, if any, piston movement is anticipated where the O-ring seal 50 is located, and therefore this may be considered a static seal for all practical purposes. Another static O-ring seal 51 is located between the valve body 41 and the bonnet 44 for preventing leakage from the sealant cavity 48. Thus, the two O-ring seals 50, 51 are arranged in series and provide redundant backup to resist leakage of process fluid through the sealant cavity.

The seal packing contained in the piston sleeve portion 49 includes a pair of dynamic O-ring seals 52 arranged in fluidic series, a spacer element 53, a pair of seal retainer washers 54, a PTFE guide bushing 55, a snap ring 56 and a retaining washer 57. The snap ring 56 snaps into a groove in the piston sleeve portion 49 to axially retain the seal packing in place. The PTFE guide bushing 55 is tightly fit around the valve stem 38 to provide for low friction sliding movement of the valve member 30. The spacer element 53 axially spaces the O-ring seals 52 with the seal retainer washers 54, providing for balance and retention of the seals 52. Ports 58 extend through the spacer element 53 such that a pressurized cylindrical ring of lubricant surrounds the valve stem 38 between the seals 52 such that the lubricant acts upon each of the dynamic seals 52.

A cover 59 is provided that encloses the packing and piston to prevent dust and other external contaminants from damaging the sealing arrangement 46. The cover 59 can be removed to manually check the level of lubricant which is indicative of how well the seals 50, 51, 52 are working. Specifically, the end of the piston sleeve portion acts as a sealant level indicator 61. When the sleeve end or sealant level indicator 61 is flush or coplanar with the top surface of the bonnet 44, the proper amount of sealant lubricant is contained in the sealant cavity 48. If the sealant level indicator 61 is raised above the top surface of the bonnet 44 by virtue of axial piston movement, such a condition is indicative that sealant has leaked out. A partitioned scale may be provided along the outer surface of the piston sleeve portion 49 to provide a numerical indication of lubricant level, if desired. Several advantages are provided with this seal arrangement 46, including easier manufacture and assembly, prevention of contaminants from reaching the sealing arrangement and an integral mechanism to indicate the seal lubricant level.

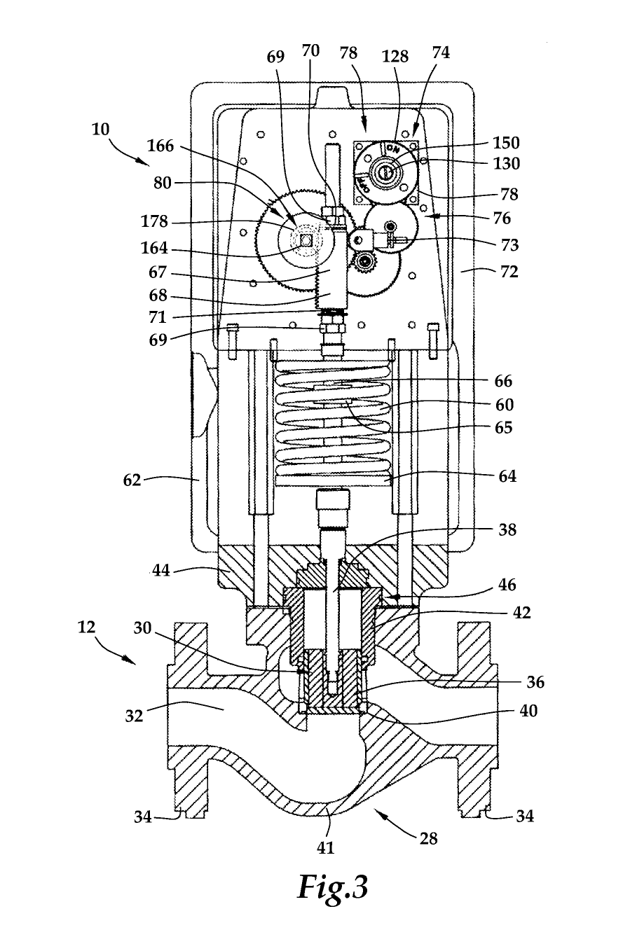

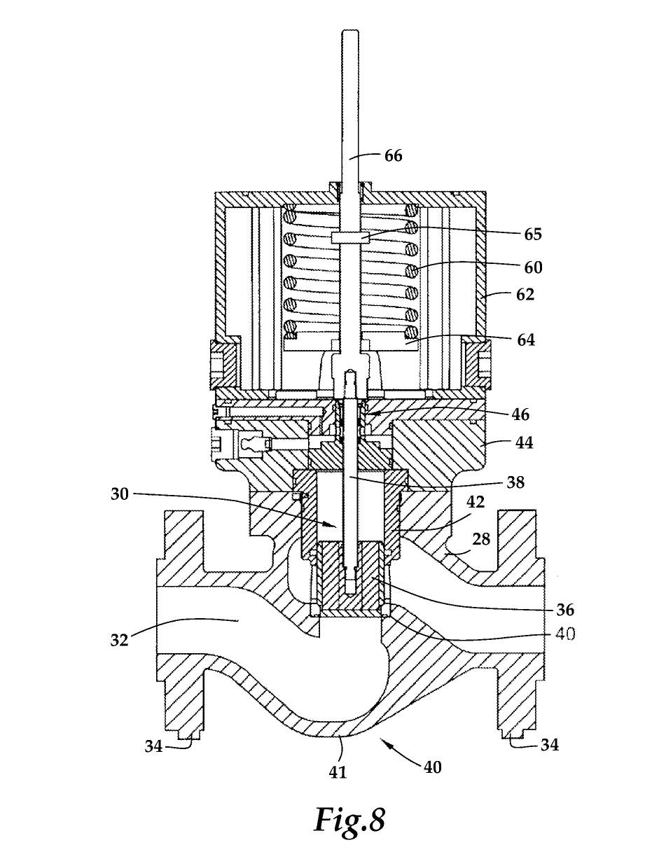

The well-head valve 12 includes a spring 60 for biasing the movable valve member 30 to either the open position or the closed position. As shown in FIGS. 3 and 8, the spring 60 is shown as a steel coil spring that is arranged to bias the valve member 30 to the closed position. A spring housing 62 mounts between the electrical actuator 10 and the valve body 41 to house and support the spring 60. The spring 60 is supported by one end of the spring housing 62 and upon a spring seat plate 64 that is supported by an actuator stem 66. One end of the actuator stem 66 engages the valve stem 38, while the other end has a drive rack 68.

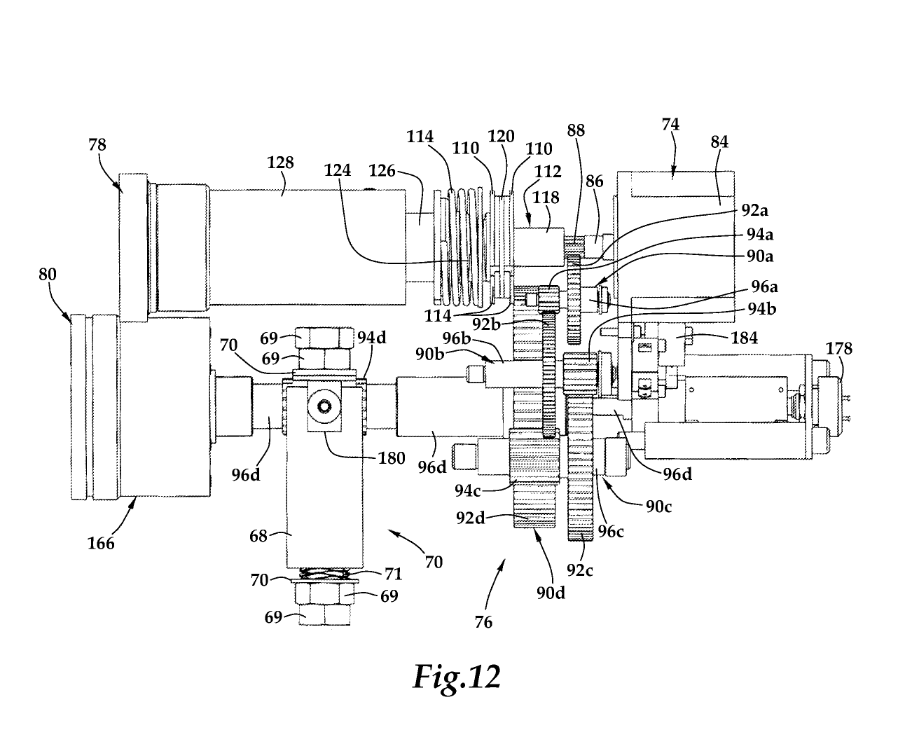

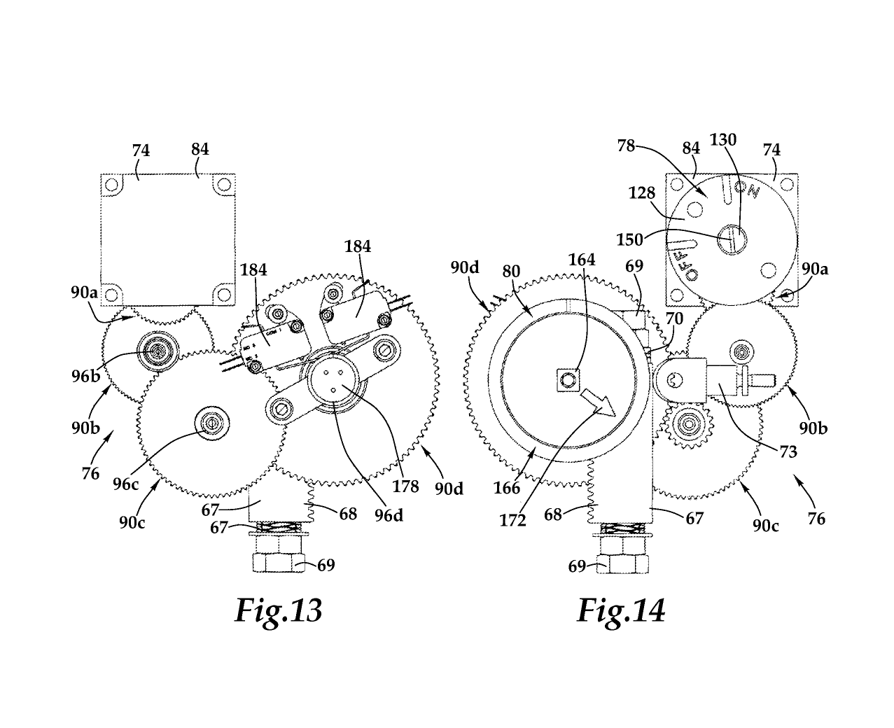

Referring to FIGS. 3 and 11-13, the drive rack 68 provides a sleeve member 67 that is slid onto the actuator stem 66 such that drive rack 68 can rotate relative to the actuator stem 66. A thrust bearing 70 better ensures free rotation of the drive rack 68, particularly since it is held axially in position by a wave spring 71. The sleeve member 67 is axially constrained between a pair of nuts 69 mounted on the actuator stem 66 and the wave spring 71 that biases the sleeve member 67 and drive rack 68 to a fixed position on the actuator stem 66. This arrangement allows for free rotation of the drive rack such that forces from the spring 60 do not cause the drive rack 68 to twist, thereby preventing premature wear, but it also holds the drive rack in a fixed axial position on the actuator stem. The wave spring 71 also compresses lightly when the valve member 30 contacts the seat, thereby reducing the resulting impact load on the gears. Another alternative to a rack and pinion mechanism for converting rotational energy to linear motion is a ball screw mechanism, and that and other conversion mechanisms may be used as an alternative.

It should be noted that the spring housing 62 and spring 60 are shown in FIG. 8 to be part of the well-head valve 12. In some embodiments, the spring housing 62 and spring 60 may be part of the electrical actuator and/or integrated into components of the electrical actuator or the valve. In either event, the spring 60 can apply a biasing force to the electrically actuated valve which effectively acts both upon the valve plug member 36 and the gear reduction train 76, either directly or indirectly.

The example electrical actuator 10 also provides a support structure 65 on the actuator stem 66 that provides a feature for reversing the actuation force of the spring 60. The spring 60 may engage the other end of the spring housing 62 with the spring seating plate 64 supported by the alternative support structure 65, such that the spring as compressed between the spring seating plate 64 and the spring housing 62, biases the valve toward the open position. Thus, the spring is reversible such that the electrically actuated well-head valve can be configured to bias the well-head valve either open or closed.

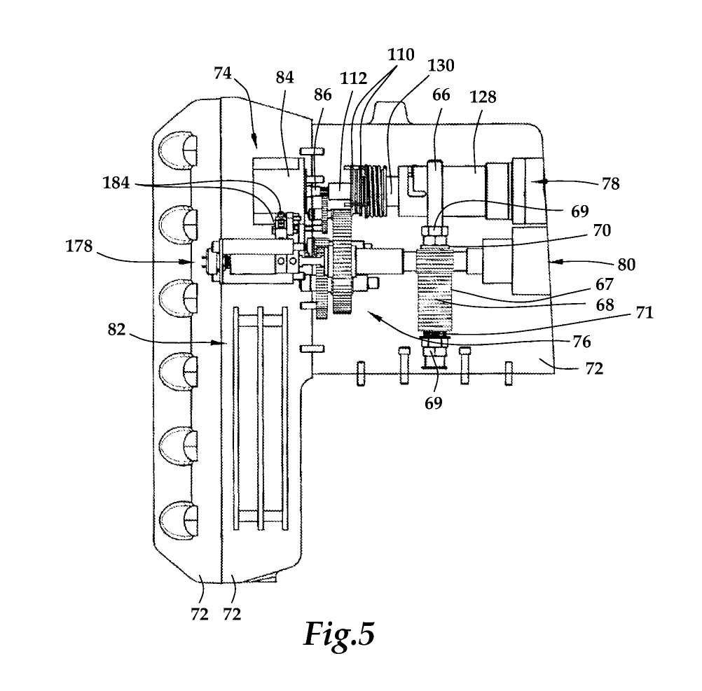

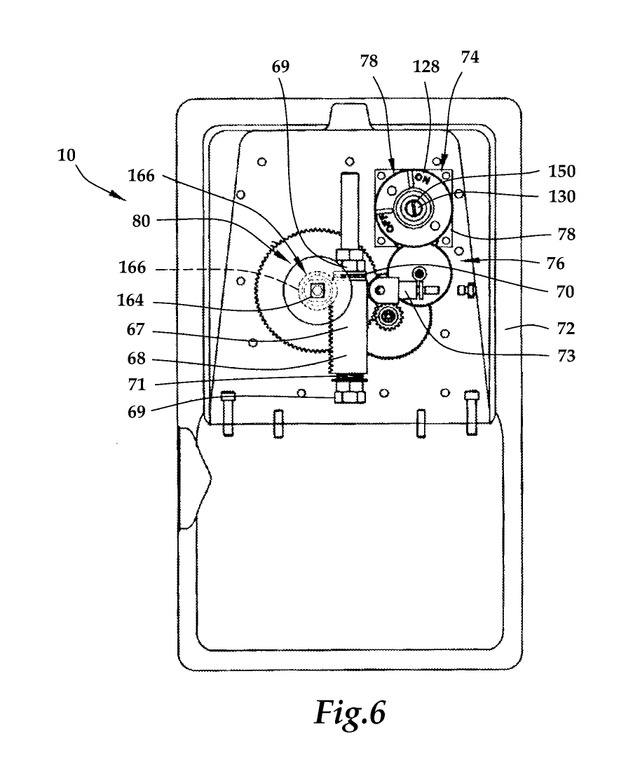

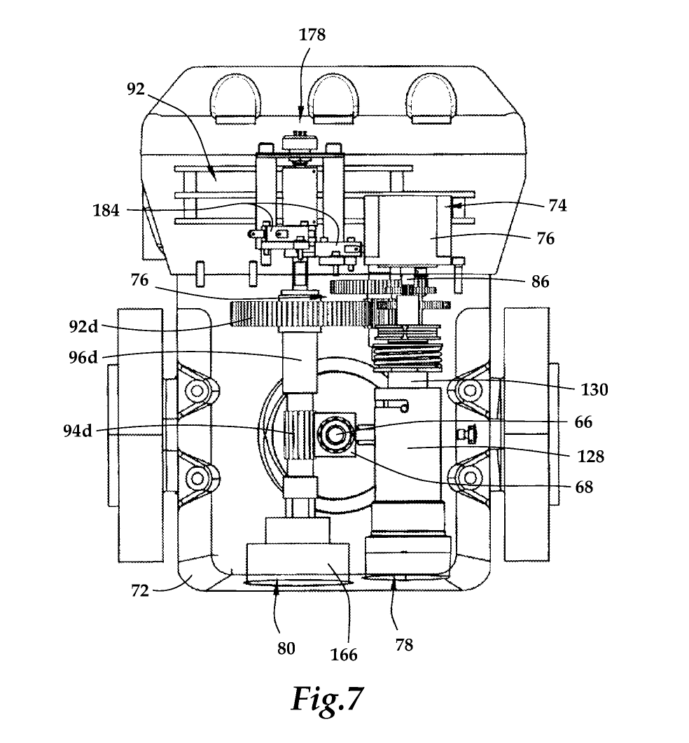

Referring to FIGS. 2-7, the example electrical actuator 10 includes an actuator housing 72 (e.g., comprised of several aluminum shells fastened together, preferably in a leak proof manner) that generally contains and supports an electric motor 74, a gear reduction train 76, a brake mechanism 78, a manual override mechanism 80 and a motor driver generically indicated as a motor controller 82. The actuator housing 72 mounts onto the spring housing 62. The electric motor 74 is a non-incentive type motor that prevents spark formation when the electrical actuator is used around natural gas or other flammable fluids and thereby further reduces the potential for a hazardous situation should there be gas leakage. Other potential appropriate spark free types of motors include a brushless DC motor, and a spark-free AC motor.

In operation, the controller 82 selectively energizes the electric motor 74. The electric motor 74 can be operated by the controller 82 in a hold mode for holding the current position of the well-head valve 12 and in an actuation mode for driving the well-head valve 12. The electrical motor consumes between 1 and 3 watts in the hold mode (to provide a force that holds a current valve position with the brake off) and between 4 and 12 watts in the actuation mode. This very low power consumption makes the electrical actuator 10 capable of operating solely off an existing electrical power supply provided by a solar panel 24 and battery 26 (which local power source may have been originally intended for regulating electro-pneumatic well-head valves).

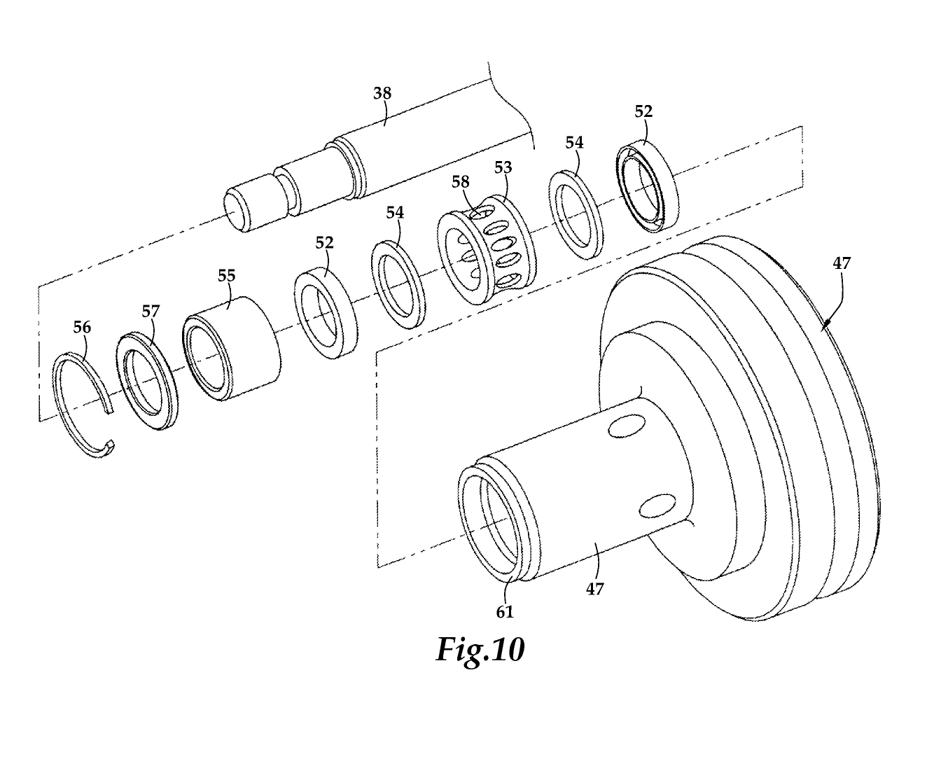

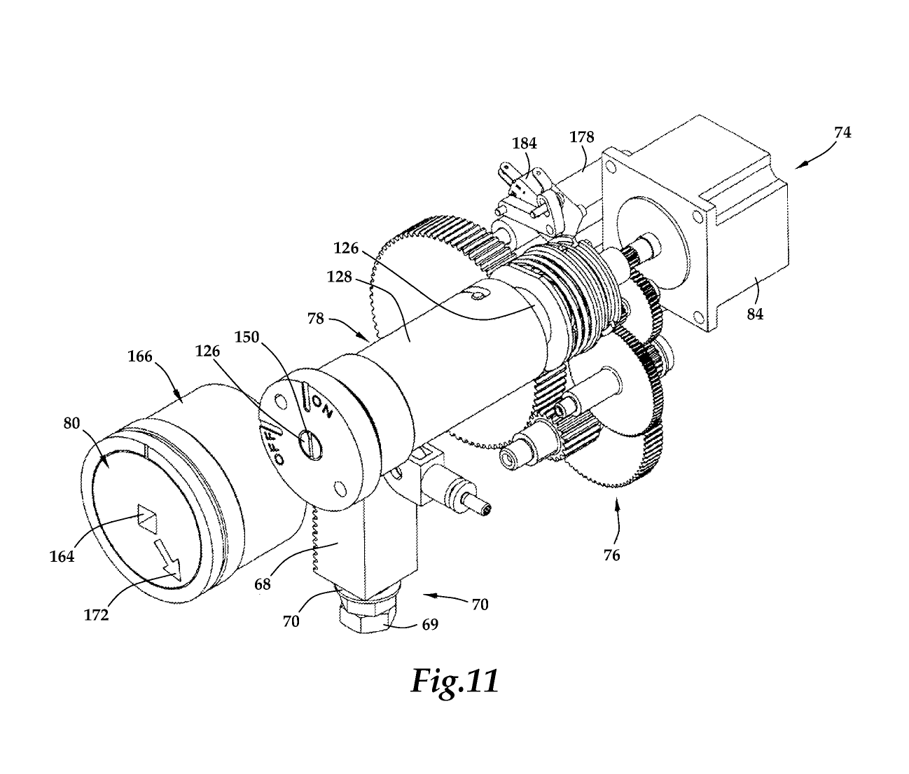

Referring to FIGS. 11-14, the electric motor 74 includes a motor housing or stator 84 mounted in fixed relation relative to the actuator housing 72 and a rotor comprising an output shaft 86. The output shaft 86 rotates relative to the stator 84. The output shaft 86 integrally provides a pinion gear 88 thereon (either by machining the output shaft or mounting a separate gear cog mounted thereto) which provides an input for the gear reduction train 76. The gear reduction train 76 comprises a plurality of individual reduction gears 90a-d that each comprise a larger upstream gear cog 92a-92d and smaller downstream gear cog 94a-94d (i.e. a “pinion” gear) that are mounted on a common gear shaft 96a-96d.

The gear shafts 96a-96d are rotatably mounted or supported for rotation by the actuator housing 72 in parallel relationship. The pinion gear 88 on the output shaft 86 is meshed with the larger cog 92a of the first reduction gear 90 such that the force is amplified from the motor output shaft 86 to the first gear shaft 96a. The other gears in the gear reduction train are similarly arranged with the smaller gear cogs 94a-94c driving the larger gear cogs 92b-92d, respectively. As the motor rotates, the electrical actuation force provided by the motor 74 is applied and amplified across the gear reduction train 76 from the motor output shaft 86 to the rotary output, which is then applied by the last smaller pinion gear cog 94d. The smaller gear cog 94d is meshed with the drive rack 68 to drive the drive rack 68 and thereby convert rotational energy into linear translation energy. A spring biased cam element 73 supported by the actuator housing 72 keeps the racked biased against the pinion gear cog 94d in meshed relation. In some embodiments, this arrangement may be used as a torque limiting device to prevent damage in the event of error or an over-torqueing situation. Another alternative to a rack and pinion mechanism for converting rotational energy to linear motion is a ball screw mechanism, and that and other conversion mechanisms may be used as an alternative.

In order to be sufficient for driving the example well-head valve 12 in well-head valve systems 14, in some embodiments, the gear train can have a gear reduction ratio of at least 100:1, and in some embodiments at least 400:1. With such a substantial gear reduction ratio, a small motor force (e.g. consuming 4-12 watts for driving the valve with current motor technology) is amplified by the gear reduction train to provide sufficient actuation force for driving and positioning the valve 12 against spring forces and/or fluid forces, which can be very substantial in view of the fact that well pressures can vary in a range of about 10-900 psi. In some implementations, the speed of the actuation may be decreased substantially with the slew time of the well-head valve 12 between fully open and closed positions taking about 1-5 minutes. It has been realized that a slow slew time is acceptable and does not appreciable effect well production control (e.g., since production often occurs 24 hours a day with demanded changes in well output occurring on a relatively infrequent basis). This may also be true when considering the significant advantages associated with reducing, and in fact eliminating for all practical purposes, all fugitive gas emissions using the local power source typically provided at well-head valve sites.

Multiple position sensing devices are employed in the disclosed exemplary embodiment. First, the motor controller 82 integrally incorporates an analog position sensor 176 that derives position of the rotary output from motor position control signals sent to the electric motor 74. The analog position sensor is a form of an accumulator or counter that adds numbers and subtracts numbers from a count as the electric motor 74 is driven to electronically derive position of the valve 12. The changes in valve position are linearly proportional to the changes in the count of the analog position sensor 176. The disclosed embodiment also includes a redundant position sensor electrically wired and providing feedback to the motor controller 82, which is shown in the form of a potentiometer 178. The potentiometer 178 is positioned by a cam that is acted upon by an eccentric surface on an extended portion of the last gear shaft 96. The potentiometer 178 provides redundant feedback that is used to check the accuracy of the analog position sensor 176 which could have error should there be a loss of electrical power or slippage in the electric motor 74. Finally, the disclosed embodiment may also include limit switches 184 that are mounted proximate the last gear shaft 96d at set points representing the end of travel for the well-head valve 12 also defined as the fully open and fully closed positions. The extended output gear shaft 96d includes cam eccentrics which trigger the limit switches 184 at the set points. The limit switches 184 are electrically wired to a customer interface to provide indication of when the valve is at a set point. This provides independent feedback to check accuracy of operation. In some implementations, the limit switch signals can be used to shut off power to the motor 74 to ensure that the controller 82 does not signal the motor to drive the valve past either of the fully open or closed positions. The limit switches 184 are also adjustable and manually rotatable relative to the output shaft 96d such that if an end user wishes to define a different end of travel range, the end user can manually configure and define the end of travel range as he deems fit.

Referring to FIG. 1, the exemplary system 14 may also include a wireless transceiver 186 powered by the local power source that is in electrical communication with one or both of the controllers 22, 82. It should be noted that the first controller 22 is provided at a well-head valve site typically external to the electrical actuator 10 to provide system level control. The motor controller 82 is more of a motor driver to facilitate control over the driving of the electrical actuator 10 and positioning of the well-head valve 12. In any event, the wireless transceiver 186 can receive remote control input and demand signals wirelessly from a remotely positioned transceiver 188, such that either or both of the controllers 22, 82 can be remotely controlled to adjust position of the well-head valve 12 wirelessly. The transceiver 186 can also transmit feedback to a remote location and thereby inform maintenance personnel about the operating parameters at the well-head site (e.g. flow rate, valve position, power levels, malfunctions, etc.). In some embodiments, the exemplary system 14 may include a different form of wired or wireless transceiver, configured to transmit and/or receive signals over wired or wireless connections or media, with or without wires (e.g., radio frequency, wires, fiber optics, ultrasonic or other oscillatory communications, laser-based or other optical links).

Another alternative aspect of an embodiment may be the incorporation of a sleep mode for the electrical actuator 10, in which it consumes virtually no electrical power and powers itself down automatically when the valve 12 is correctly positioned. According to this mode, the brake mechanism 78 is normally in the on position and therefore acting as a dynamic brake arranged to provide resistance to movement of the valve 12. Since the brake mechanism 78, when on, provides sufficient force to prevent backdriving of the gear train upon power loss, the brake mechanism 78 is operable to hold a current position for the well-head valve 12. The electrical motor 74 provides sufficient force and torque to cause the brake to slip and thereby overpower the brake to move the well-head valve 12 when desired. The sleep mode further provides for energy efficiency and lowers power consumption when electrical power in these remote locations is scarce.

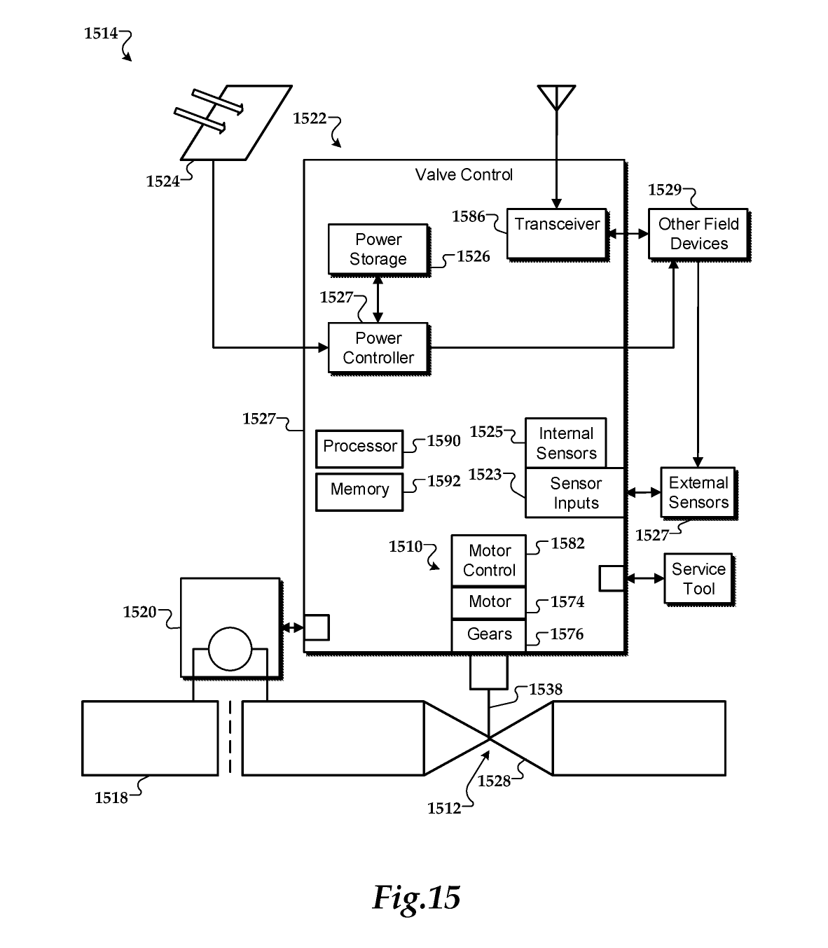

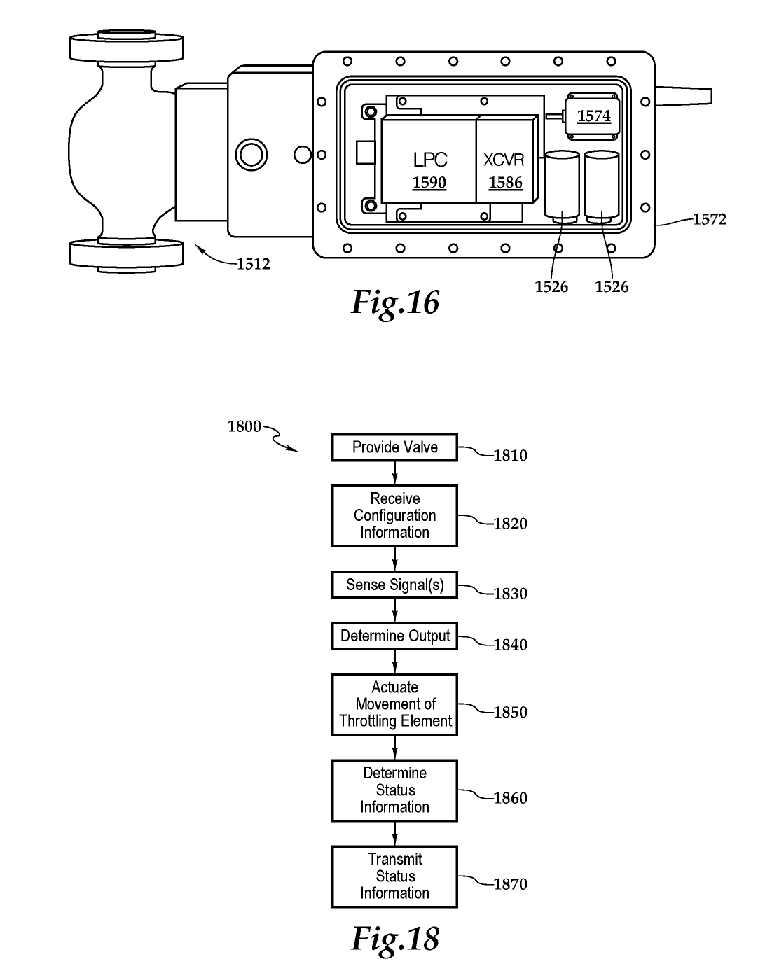

FIG. 15 is a block diagram of an example natural gas well production system 1514. The natural gas well production system 1514 is an example application and operational environment for an example electrical actuator 1510. A well-head valve 1512 regulates a production output of a natural gas production well (e.g., the natural gas production well 16 of FIG. 1) through a collection pipe 1518. The well-head valve 1512 is mounted in the collection pipe 1518 in fluid series with a sensor 1520. The degree of opening of the well-head valve 1512 and the natural gas pressure of the well (which typically ranges between about 10-900 psi or higher for some production wells) determine the natural gas flow rate through the collection pipe 1518. The sensor 1520 measures one or more properties of natural gas that flows through the pipe 1518 (e.g., flow, differential pressure, gage pressure, temperature). The sensor 1520 provides electrical feedback representative of the sensed property/properties to an electronic controller 1522 for closed loop control over the electrical actuator 1510 and the well-head valve 1512. FIG. 16 is another block diagram of the example electronic controller 1522.

Since the well may be located remote from a commercially available electrical power supply, the system 1514 is shown to include a local electrical power supply which typically comprises a solar panel 1524, a power storage system 1526 (e.g., a battery), and a power controller 1527. In use, the solar panel 1524 generates electrical power, and the power controller 1527 directs the generated power to power the electronic controller 1522, to power a collection of external field devices 1529, and/or to charge the power storage system 1526. The power controller 1527 is also configured to control the draw of electrical power from the power storage system 1526 to power the electronic controller 1522 and/or the external field devices 1529, in some embodiments, in combination with power generated by the solar panel 1526. In some embodiments, the solar panel 1524 can be replaced by a wind turbine, a fluid turbine, a fuel cell, or any other appropriate form of renewable or non-renewable power source. In some embodiments, the power storage system 1526 can be a battery, a flywheel, a capacitor, a thermal energy storage system, a fluid pressure storage system, a spring, a mechanical potential storage system, or any other appropriate device that can store and provide power that can be converted to and/or from electrical energy.

The electrical actuator 1510 includes a motor controller 1582 and a motor 1574 operably coupled to the well-head valve 1512. In some implementations, the electrical actuator 1510 can replace pneumatic actuation systems without needing any additional power or electrical generation, using only the existing local electrical power supply. In some implementations, the electronic controller 1514 may be employed as a retrofit device to replace pneumatic actuating systems or other valve actuating systems at existing well-head valves. In some embodiments, additional expansion of the electrical generation or storage capabilities may be included.

The electrical actuator 1510 receives control signals from a processor 1590 based on program instructions and configuration values stored in a memory module 1592. The processor 1590 is a local process controller (LPC) within the housing 1572. The processor 1590 is configured to monitor a number of diagnostic functions enabling predictive diagnostics to detect early signs of degradation to trigger service or maintenance activities prior to interruption of service. In some implementations, the information available could include prediction (time) of interruption, parts and service that may be required, and determine a reduced functionality schedule until service or maintenance can be provided. The processor 1590 is also configured to receive confirmation on reduced functionality, planned maintenance timing, and ability to request more data, as signals provided by the transceiver 1586.

The processor 1590 is a programmable controller capable of operation with less than one watt of input power. The electrical actuator 1522 is configured with internal conductor trace spacings, components, and other design considerations to resist the creation of high surface temperatures which may exceed the limits of Class I, Div. 1 allowances, and that the ratings of the components used are well within their rated limits.

In some embodiments, the well-head valve 1512 may be a linearly translatable valve, a rotary valve, or any other appropriate form of movable/positionable valve. In some embodiments, the well-head valve 1512 may be a linear type valve having a valve housing and a linearly translatable valve member, such as in the example well-head valve 12 of FIG. 1. The valve housing 1528 includes a valve body defining a flow passage (e.g., the valve body 41, the flow passage 32). A valve stem 1538 extends through the valve housing 1528 and is acted upon by the electrical actuator 1510. The valve stem 1538 transmits the selective positioning force from the electrical actuator 1510 to actuate the well-head valve 1512.

The example electrical actuator 1510 includes an actuator housing 1572 (e.g., comprised of several aluminum shells fastened together, preferably in a leak resistant manner) that generally contains and supports the motor 1574, a gear reduction train 1576, the motor controller 1582. In some embodiments, the actuator housing 1572 can be configured to be mounted onto the pipe 1518. The housing 1572 is configured for outdoor locations and/or hazardous locations (e.g., locations requiring the use of Class I, Division 1 rated equipment). In some embodiments, the motor 1574 can be a non-incentive type stepper motor that resists spark formation when the electrical actuator is used around natural gas or other flammable fluids and thereby reduces the potential for a hazardous situation should there be gas leakage. Other potential appropriate spark resistant types of motors include brushless DC motors, and “spark-free” AC motors.

In operation, the controller 1582 selectively energizes the electric motor 1574. The electric motor 1574 can be operated by the controller 1582 in a hold mode for holding the current position of the well-head valve 1512 and in an actuation mode for driving the well-head valve 1512. The electric motor 1574 consumes between 1 and 3 watts in the hold mode (e.g., to provide a force that holds a current valve position with a brake off) and less than three watts in the actuation mode. This very low power consumption makes the electrical actuator 1510 capable of operating solely off an existing electrical power supply provided by the solar panel 1524 and the power storage system 1526 as directed from wirelessly received setpoint conditions and internal or external transducer feedback.

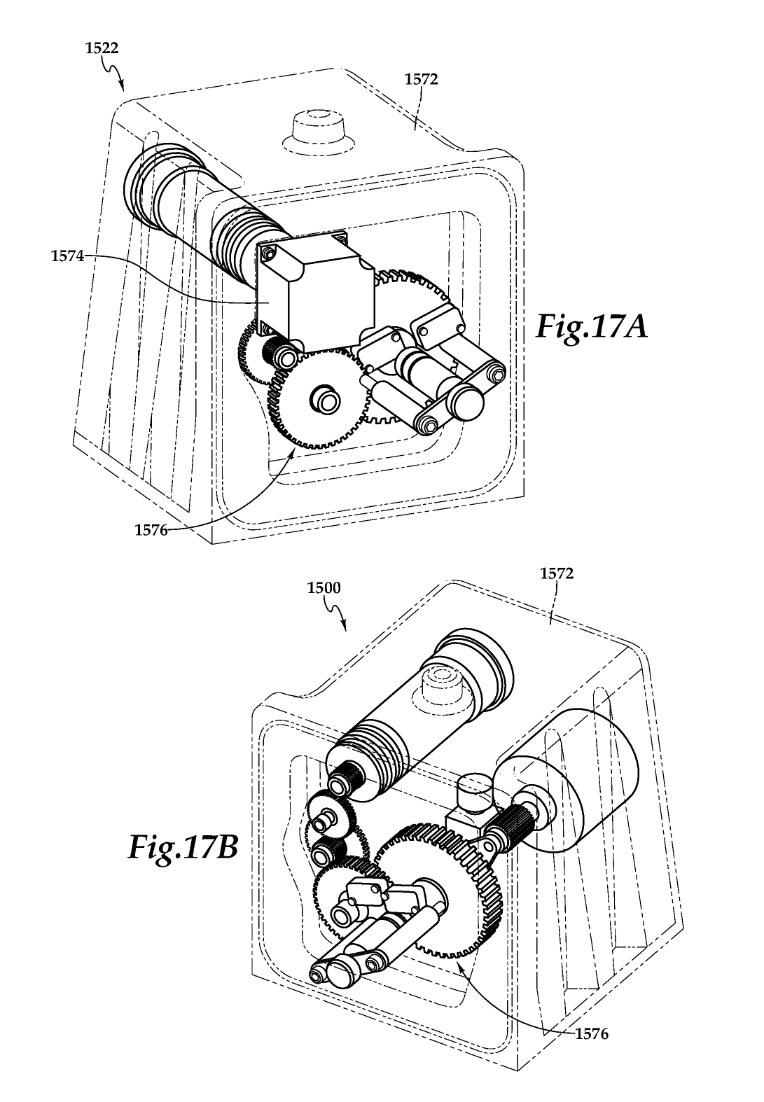

FIGS. 17A-17B are partial cutaway views of the example electrical controller 1522. As shown in FIGS. 17A-17B, the electric motor 1574 includes a motor housing or stator (e.g., the stator 84) mounted in fixed relation relative to the actuator housing 1572 and a rotor comprising an output shaft (e.g., the output shaft 86). The output shaft rotates relative to the stator. The output shaft integrally provides a gear thereon (not shown) which provides an input for the gear reduction train 1576. In some embodiments, the gear reduction train 1576 can be the gear reduction train 76.

As the electric motor 1574 rotates, the electrical actuation force provided by the electric motor 1574 is applied and amplified across the gear reduction train 1576 from the motor output shaft to the valve stem 1538. In some embodiments, this arrangement may be used as a torque limiting device to prevent damage in the event of error or an over-torqueing situation. In some embodiments, a rack and pinion mechanism, a ball screw mechanism, or any other appropriate conversion mechanisms may be used for converting rotational energy to linear motion.

In some embodiments, the gear reduction train 1576 can have a gear reduction ratio of at least 100:1, and in some embodiments at least 400:1 (e.g., 458:1). With such a substantial gear reduction ratio, a small motor force (e.g. consuming under 3 watts for driving the valve 1512) is amplified by the gear reduction train 1576 to provide sufficient actuation force (e.g., 630 ft/lb) for driving and positioning the valve 12 against spring forces and/or fluid forces in addition to a return spring (not shown) (e.g., 580 ft/lb), which can be very substantial in view of the fact that well pressures can vary in a range of about 10-900 psi. In some implementations, the speed of the actuation may be decreased substantially with the slew time of the valve 1512 between fully open and closed positions taking about 1-5 minutes. It implementations, slow slew times can be acceptable and may not appreciably effect well production control (e.g., since production often occurs 24 hours a day with demanded changes in well output occurring on a relatively infrequent basis).

Referring again to FIGS. 15-17B, the electronic controller 1522 includes collection sensor inputs 1523 configured to receive feedback signals from a collection of internal sensors 1525 and a collection of external sensors 1527. The internal sensors 1525 are integrally connected to the electronics within the electronic controller 1522. In some embodiments, the sensors 1525, 1527 can include multiple position sensing devices. In some embodiments, the sensors 1525, 1527 can provide signals that can enable the processor 1590 to perform a variety of functions such as positive flow rate control, backpressure regulation, downstream pressure regulation, detection of problems with the production well or production equipment which it is controlling, level sensing, temperature sensing, monitoring of flow metering equipment such as orifice flow meters (e.g., P1, dP, temperature), mass flow meters (e.g., analog signals, frequency, pulse counters), Modbus serial and/or internet protocol (IP) communications, battery supply voltage, and any other appropriate control and/or monitoring function. In some implementations, the processor 1590 can identify reduced functionality of the system 1514 based on sensor health, by leveraging other sensor information from other electronic controllers 1522 on the site, sensor health based service and maintenance can also be provided.

In some embodiments, the sensors 1525, 1527 can satisfy the characteristics for inclusion into a Class I, Division 1 device. This typically requires that the sensors are fully sealed, have no arcing or sparking parts, operate within the temperature allowances of the components, and do not create high temperature surfaces which can ignite a flammable gas or liquid. In addition, fluid port interfaces can be configured to provide the necessary flame paths via at least 5 threads or minimum flat joint distances of at least 12 mm.

In some embodiments, the sensors 1525, 1527 can have an accuracy of at least 0.15% of full scale, and specific ranges can be used to ensure that a predetermined accuracy is achieved. In some embodiments, the sensors 1525, 1527 can be 0-5 VDC output devices to enhance low power operation of the electrical controller 1522.

In some embodiments, the motor controller 1582 can integrally include an analog position sensor that derives position of the rotary output from motor position control signals sent to the electric motor 1574. In some embodiments, the analog position sensor can be a form of an accumulator or counter that adds numbers and subtracts numbers from a count as the electric motor 1574 is driven to electronically derive position of the valve 1512. In some implementations, the changes in valve position can be linearly proportional to the changes in the count of the analog position sensor. In some embodiments, the electronic controller 1522 can include a redundant position sensor electrically wired and providing feedback to the motor controller 1582, (e.g., a potentiometer that provides redundant feedback that is used to check the accuracy of the analog position sensor which could have error should there be a loss of electrical power or slippage in the electric motor 1574). The sensors 1525, 1527 may also include limit switches that are configured to detect the end of travel for the well-head valve 1512 (e.g., the fully open and fully closed positions). In some embodiments, the gear reduction train 1576 can include cam eccentrics which trigger the limit switches at predetermined set points.

Referring to FIG. 15, the example system 1514 also include a wireless transceiver 1586 powered by the power controller 1527. In general, the wireless transceiver is used to transmit process information gathered by the internal sensors 1525 and the processor 1590 to a remote operating station. The transceiver 1586 is configured as a bi-directional wireless transceiver (XCVR) within the controller 1522 to communicatively connect the controller 1522 with other elements of the process control stream, to receive operating instructions from remote manual or automatic control systems, and/or to transmit process control data and diagnostics information to operators or maintenance personnel.

Once a wireless connection has been established between the wireless transceiver 1586 and a remote control station, at least one of several functions can be performed. For example, the electronic controller 1522 can set the process variable setpoint (e.g., upon which the programmable controller performs its control functions and by which it regulates the valve position to match the setpoint value), transmit process variable signals from the sensors 1525, 1527, transmit an identifier of the electronic controller 1522, transmit the position of the valve shaft, transmit status information from the processor 1590 (e.g., detected fault conditions of the electronic controller 1522 and/or the sensors 1525, 1527), transmit the geographic location of the electronic controller 1522, transmit the process description of the valve/actuator assembly, transmit values associated with the condition of the power input, and/or transmit any other appropriate information.

It should be noted that the controller 1522 is provided at a well-head valve site to provide system level control. The motor controller 1582 facilitates control over the driving of the electrical actuator 1510 and positioning of the well-head valve 1512. The wireless transceiver 1586 can receive remote control input and demand signals wirelessly from a remotely positioned transceiver (not shown), such that the controller 1522 can be remotely configured to adjust the position of the well-head valve 1512 wirelessly. In some implementations, the transceiver 1586 can also transmit feedback to a remote location and thereby inform maintenance personnel about the operating parameters at the well-head site (e.g. flow rate, valve position, power levels, malfunctions, predicted service needs, etc.).

The controller 1522 of the exemplary system includes a sleep mode, in which the controller 1522 consumes virtually no electrical power and powers itself down automatically when the valve 1512 is correctly positioned. According to this mode, a brake mechanism (e.g., the brake mechanism 78) can normally be in the on position and therefore act as a dynamic brake arranged to provide resistance to movement of the valve 1512. In some implementations, the brake mechanism when on can provide sufficient force to prevent backdriving of the gear reduction train 1576 upon power loss (e.g., the brake mechanism can hold a current position for the well-head valve 1512). In some embodiments, the electric motor 1574 can provide sufficient force and torque to cause the brake to slip and thereby overpower the brake to move the well-head valve 1512 when desired. In some implementations, the sleep mode can also enhance energy efficiency and can lower power consumption when electrical power is scarce (e.g., remote locations).

In some implementations, the programming of the electronic controller 1522 can be customized by the user/owner to enable a number of automated processes within the local area of control of the valve 1512. For example, control functions can include continuous process control such as pressure regulation and flow control, timing and sequential functions such as level controls, pressure, flow rate, level, timing sequences to manage a process variable by operating the motor and gear reduction system thereby changing the position of the valve closure system, and plunger lift systems.

The processor 1590 is programmed with a number of pre-defined pressure and/or flow rate setpoint trajectories. In some implementations, these trajectories can be used to stimulate the process to determine certain characteristics of an oil, gas, or water production well, determine porosity levels of oil, gas, or water bearing formations, determine well size based on rate of change data, or other similar applications.

In addition to the pre-defined control functions, the processor 1590 can be configured using an industry standard programming language using structured text, functional block diagrams, ladder logic, or a combination of the above. This allows the user to modify functions or add custom functions as needed to apply the electronic controller 1522 in new or unique ways. In some implementations, the processor 1590 can be programmed using programming languages that are intuitive and common to those used for other process control applications. In some implementations, the flexibility of the user programming capability allows the electronic controller 1522 to be adapted for a variety of application and data gathering purposes. In some implementations, the electronic controller 1522 can also identify other valves on the site. In some implementations, pre-existing standard process control applications (e.g., backpressure control, flow rate control, gas flow, liquid flow, pressure regulation, level control, plunger lift, manifold pressure balancing, flow balancing, gas injection, output regulation) can allow the user to identify the type of control valve and the role of other valves in the same application, process, or site.

FIG. 18 is a flow diagram of an example process 1800 for operating an example electrically actuator valve with integrated control module, such as the example electronic controller 1522 of FIG. 15.

At 1810, a process control valve is provided that includes a fluid valve body having an inlet for receiving fluid, an outlet for discharging fluid, a fluid flow passage connecting the inlet and outlet, and a controllable throttling element which is moveable to selectively vary the cross-sectional area of flow of at least a portion of the passage, a valve actuator coupled to the valve body and responsive to control signals for selectively moving the throttling element, a controller integrated with the process control valve and having a processor for receiving said signal and configuration information, for developing an output dependent upon the configuration information and the received signal, and for developing the status information. For example, the natural gas well production system 1514 includes the example electrical actuator 1510, the well-head valve 1512, and the electronic controller 1522.

At 1820 a communication system integrated with the process control valve receives a collection of configuration information. For example, the wireless transceiver 1586 can receive configuration settings from a remotely connected station.

At 1830, a sensor (e.g., the sensors 1525, 1527) integrated with the process control valve (e.g., the electronic controller 1522) senses at least one of absolute pressure, gage pressure, differential pressure, flow, and temperature within the fluid flow passage as a sensor signal.

At 1840, a processor associated with a controller integrated with the process control valve determines an output based on the configuration information and the signal and configuration information. For example, the processor 1590 can use setpoints retrieved from the memory module 1592 and feedback from the sensors 1525, 1527 to determine a target position for the valve 1512.

At 1850, the valve actuator actuates movement of the controllable throttling element based on the output to selectively vary the cross-sectional area of flow of at least a portion of the passage. For example, the processor 1590 can command the motor controller 1582 to drive the electric motor 1574 such that the valve 1512 is at a predetermined position ranging from fully closed to fully open.

At 1860, the processor determines a collection of status information based on said sensor signal and said configuration information. For example, the processor 1590 can determine the position of the valve 1512, pressure of fluid flowing through the valve 1512, temperature of fluid flowing through the valve 1512, malfunctions and/or predicted time-to-failure of components of the valve 1512 and/or the electronic controller 1522, and any other appropriate information that can describe the operation of the electronic controller 1522.

At 1870, the communication system transmits the status information. For example, the processor 1590 can provide process and/or status information to the wireless transceiver 1586 for transmission to a remote receiving station.

In some implementations, the sensor signal can include a first pressure signal based on a first pressure sensor disposed at the inlet of the valve body and representing the pressure of the fluid at the inlet, and a second pressure signal based on a second pressure sensor disposed at the outlet of the valve body and representing the pressure of the fluid at the outlet, and the process 1800 can include receiving the first pressure signal and said pressure signal and developing an output dependent upon the received signals, determining a fluid pressure drop across the valve body based on the first pressure signal and second pressure signal, storing a predetermined fluid pressure drop value, comparing a determined fluid pressure drop with the stored fluid pressure drop value, determining a difference signal whose magnitude represents a difference between the compared values, and moving, by the valve actuator, the throttling element to vary the fluid pressure drop across the valve body to more closely match the stored fluid pressure drop value.

In some implementations, the process 1800 can include storing a predetermined temperature value, comparing a temperature signal representing the temperature of the fluid with a stored temperature value, determining a difference signal whose magnitude represents the difference between the compared values, moving, by the valve actuator, the throttling element to thereby vary the temperature of fluid flowing in the passage to more closely match the stored temperature value.

In some implementations, the process 1800 can include determining, by the controller and based on a temperature signal representing the temperature of the fluid in the fluid flow passage, determining, by the controller and based on a throttling element position sensor, a flow signal representing the flow capacity of the valve body, and determining, by the controller, a flow rate of the fluid in the passage based on the sensor signal, the temperature signal, and the flow signal.

In some implementations, the process can include storing, by the controller, a predetermined flow rate value, comparing, by the controller, a determined flow rate with the stored flow rate value, determining, by the controller, a difference signal whose magnitude represents the difference between the compared values, and providing, by the controller, control signals for application to the actuator to cause the actuator to move the throttling element to vary the flow rate to more closely match the stored flow rate value.

In some implementations, the process 1800 can include receiving, by the controller, program instructions operable to perform control functions comprising pressure regulation, flow control, level control, and plunger lift control. In some implementations, the status information can include one or more of a predicted time of malfunction, an identity of a part, an identity of a preventative or remedial service, and a schedule identifying a period of reduced functionality until service or maintenance can be provided. In some implementations, the configuration information can include one or more of a flow set point, a temperature set point, a pressure set point, a confirmation of reduced functionality, a planned maintenance time, and a request for additional data.

Although the present invention is shown for use in controlling or regulating natural gas at a well-head, the present invention may have other applications. For example, the controller 1522 may be used with a valve for regulating the flow of other types of process fluid, including other types of gases and liquids.

Although a few implementations have been described in detail above, other modifications are possible. For example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A process control valve comprising:
a fluid valve body having an inlet for receiving fluid, an outlet for discharging fluid, a fluid flow passage connecting the inlet and outlet, and a controllable throttling element which is moveable to selectively vary the cross-sectional area of flow of at least a portion of the passage;
a valve actuator coupled to the valve body and responsive to control signals for selectively moving the throttling element;
a sensor for producing at least one signal representative of at least one of absolute pressure, gage pressure, differential pressure, flow, and temperature within the fluid flow passage;
a communication system for receiving configuration information and transmitting status information; and
a controller comprising a processor for receiving said signal and configuration information, for developing an output dependent upon the configuration information and the received signal, and for developing the status information.

2. The process control valve of claim 1, said sensor comprising:
a first pressure sensor disposed at the inlet of the valve body for producing a first signal representing the pressure of the fluid at the inlet;
a second pressure sensor disposed at the outlet of the valve body for producing a second signal representing the pressure of the fluid at the outlet;
a receiver for receiving said first and second signals and for developing an output dependent upon the received signals; and said controller is configured to:
determine the fluid pressure drop across the valve body from the first and second signals;
store a predetermined fluid pressure drop value;
compare the determined fluid pressure drop with the stored fluid pressure drop value and for producing a difference signal whose magnitude represents a difference between the compared values; and
determine control signals for application to the actuator to cause it to move the throttling element to thereby vary the fluid pressure drop across the valve body to more closely match the stored fluid pressure drop value and reduce the magnitude of the difference signal.

3. The process control valve of claim 2, wherein said controller comprises a processor for:
storing a predetermined temperature value;
comparing the signal representing the temperature T1 of the fluid with the stored temperature value and for producing a difference signal whose magnitude represents the difference between the compared values;
producing control signals for application to the actuator to cause it to move the throttling element to thereby vary the temperature of fluid flowing in the passage to more closely match the stored temperature value and reduce the magnitude of the difference signal.

4. The process control valve of claim 1 further comprising:
a temperature sensor for producing a temperature signal representing the temperature of the fluid in the fluid flow passage; and
a throttling element position sensor for producing a flow signal representing the flow capacity of the valve body; and
wherein said controller is configured to determine the flow rate of the fluid in the passage from the signal, the temperature signal, and the flow signal.

5. The process control valve of claim 1, wherein said processor is adapted for:
storing a predetermined flow rate value;
comparing the determined flow rate with the stored flow rate value and for producing a difference signal whose magnitude represents the difference between the compared values; and
producing control signals for application to the actuator to cause it to move the throttling element to thereby vary the flow rate to more closely match the stored flow rate value and reduce the magnitude of the difference signal.

6. The process control valve of claim 1, further comprising a power system for powering one or more of said valve actuator, said sensor, said communication system, and said controller, wherein the instantaneous power drawn from said power system does not exceed 3 Watts.

7. The process control valve of claim 1, further comprising an enclosure configured to protect said valve actuator, said sensor, said communication system, and said controller in hazardous locations requiring Class I, Division 1 rated equipment.

8. The process control valve of claim 1, wherein said processor is configured for receiving program instructions operable to perform control functions comprising one or more of pressure regulation, flow control, level control, and plunger lift control.

9. The process control valve of claim 1, wherein said status information comprises one or more of a predicted time of malfunction, an identity of a part, an identity of a preventative or remedial service, and a schedule identifying a period of reduced functionality until service or maintenance can be provided.

10. The process control valve of claim 1, wherein the configuration information comprises one or more of a flow set point, a temperature set point, a pressure set point, a confirmation of reduced functionality, a planned maintenance time, and a request for additional data.

11. The process control valve of claim 1, wherein said communication system comprises a wireless transceiver for receiving configuration information and transmitting status information wirelessly.

12. The process control valve of claim 1, wherein said communications system comprises a wired transceiver for receiving configuration information and transmitting status information over a wired connection.

13. A method for controlling a process flow comprising:
providing a process control valve comprising:
a fluid valve body having an inlet for receiving fluid, an outlet for discharging fluid, a fluid flow passage connecting the inlet and outlet, and a controllable throttling element which is moveable to selectively vary the cross-sectional area of flow of at least a portion of the passage;
a valve actuator coupled to the valve body and responsive to control signals for selectively moving the throttling element;
a controller integrated with the process control valve and comprising a processor for receiving said signal and configuration information, for developing an output dependent upon the configuration information and the received signal, and for developing the status information;
receiving, by a communication system integrated with the process control valve, a collection of configuration information;
sensing, by a sensor integrated with the process control valve, at least one of absolute pressure, gage pressure, differential pressure, flow, and temperature within the fluid flow passage as a sensor signal;
determining, by a processor associated with a controller integrated with the process control valve and based on said signal and configuration information, an output based on the configuration information;
actuating, by the valve actuator and based on the output, movement of the controllable throttling element to selectively vary the cross-sectional area of flow of at least a portion of the passage;
determining, by said processor and based on said sensor signal and said configuration information, a collection of status information; and
transmitting, by the communication system, the status information.

14. The method of claim 13, wherein said sensor signal comprises:
a first pressure signal based on a first pressure sensor disposed at the inlet of the valve body and representing the pressure of the fluid at the inlet;
a second pressure signal based on a second pressure sensor disposed at the outlet of the valve body and representing the pressure of the fluid at the outlet;
wherein the method further comprises:
receiving said first pressure signal and said pressure signal and for developing an output dependent upon the received signals;
determining, by the controller, a fluid pressure drop across the valve body based on the first pressure signal and second pressure signal;
storing, by the controller, a predetermined fluid pressure drop value;
comparing, by the controller, a determined fluid pressure drop with the stored fluid pressure drop value;
determining, by the controller, a difference signal whose magnitude represents a difference between the compared values; and
moving, by the valve actuator, the throttling element to vary the fluid pressure drop across the valve body to more closely match the stored fluid pressure drop value.

15. The method of claim 14, further comprising:
storing, by the controller, a predetermined temperature value;
comparing, by the controller, a temperature signal representing the temperature of the fluid with a stored temperature value;
determining, by the controller, a difference signal whose magnitude represents the difference between the compared values;
moving, by the valve actuator, the throttling element to thereby vary the temperature of fluid flowing in the passage to more closely match the stored temperature value.

16. The method of claim 13 further comprising:
determining, by the controller and based on a temperature signal representing the temperature of the fluid in the fluid flow passage;
determining, by the controller and based on a throttling element position sensor, a flow signal representing the flow capacity of the valve body; and
determining, by the controller, a flow rate of the fluid in the passage based on the sensor signal, the temperature signal, and the flow signal.

17. The method of claim 13, further comprising:
storing, by the controller, a predetermined flow rate value;
comparing, by the controller, a determined flow rate with the stored flow rate value;
determining, by the controller, a difference signal whose magnitude represents the difference between the compared values; and
providing, by the controller, control signals for application to the actuator to cause the actuator to move the throttling element to vary the flow rate to more closely match the stored flow rate value.

18. The method of claim 13, further comprising receiving, by the controller, program instructions operable to perform control functions comprising pressure regulation, flow control, level control, and plunger lift control.

19. The method of claim 13, wherein said status information comprises one or more of a predicted time of malfunction, an identity of a part, an identity of a preventative or remedial service, and a schedule identifying a period of reduced functionality until service or maintenance can be provided.

20. The method of claim 13, wherein the configuration information comprises one or more of a flow set point, a temperature set point, a pressure set point, a confirmation of reduced functionality, a planned maintenance time, and a request for additional data.

21. The method of claim 13, wherein:
said communication system comprises a wireless transceiver;
receiving, by the communication system integrated with the process control valve, the collection of configuration information comprises receiving, by the wireless transceiver, the collection of configuration information wirelessly; and
transmitting, by the communication system, the status information comprises transmitting, by the wireless transceiver, the status information wirelessly.

22. The method of claim 13, wherein:
said communication system comprises a wired transceiver;
receiving, by the communication system integrated with the process control valve, the collection of configuration information comprises receiving, by the wired transceiver, the collection of configuration information over a wired connection; and
transmitting, by the communication system, the status information comprises transmitting, by the wired transceiver, the status information over a wired connection.

23. An electrically actuated valve, comprising:
an electric motor adapted to rotate an output shaft;
a gear reduction train comprising a plurality of gears comprising an input gear driven by the output shaft and a rotary output, the plurality of gears adapted to amplify force from the input gear to the rotary output when the electric motor rotates the output shaft;
a valve adapted to control fluid flow therethrough, the valve comprising a valve housing and a valve member, the valve housing defining a flow passage, the valve member movable in the valve housing between open and closed positions to control a degree of opening of the flow passage;
a spring arranged to urge the valve to one of the open and closed positions, the brake when in the on position providing sufficient resistance to hold a current position of the valve against the action of the spring, and wherein the electric motor has a sufficient rotary output force to overcome resistance of the brake when in the on position to move the valve;
a sensor for producing at least one signal representative of at least one of absolute pressure, gage pressure, differential pressure, flow, and temperature within the fluid flow passage;
a communication system for receiving configuration information and transmitting status information; and
a controller comprising a processor configured to receive said signal and configuration information, determine an output dependent upon the configuration information and the received signal, and determine the status information.

24. The electrically actuated valve of claim 23, wherein said sensor comprises:
a first pressure sensor disposed at the inlet of the valve body for producing a first signal representing the pressure of the fluid at the inlet;
a second pressure sensor disposed at the outlet of the valve body for producing a second signal representing the pressure of the fluid at the outlet;
a receiver for receiving said first and second signals and for developing an output dependent upon the received signals; and
said controller is configured to:
determine a fluid pressure drop across the valve body from the first and second signals;
store a predetermined fluid pressure drop value;
compare the determined fluid pressure drop with the stored fluid pressure drop value and for producing a difference signal whose magnitude represents a difference between the compared values; and
produce control signals for application to the actuator to cause it move the throttling element to thereby vary the fluid pressure drop across the valve body to more closely match the stored fluid pressure drop value and reduce the magnitude of the difference signal.

25. The electrically actuated valve of claim 24, wherein said controller is further configured to:
store a predetermined temperature value;
compare the signal representing the temperature of the fluid with the stored temperature value and for producing a difference signal whose magnitude represents the difference between the compared values;
produce control signals for application to the actuator to cause it to move the throttling element to thereby vary the temperature of fluid flowing in the passage to more closely match the stored temperature value and reduce the magnitude of the difference signal.

26. The electrically actuated valve of claim 23 further comprising:
a temperature sensor for producing a temperature signal representing the temperature of the fluid in the fluid flow passage; and
a throttling element position sensor for producing a flow signal representing the flow capacity of the valve body; and
wherein said controller is configured to determine the flow rate of the fluid in the passage from the signal, the temperature signal, and the flow signal.

27. The electrically actuated valve of claim 23, wherein the processor is configured to:
store a predetermined flow rate value;
compare the determined flow rate with the stored flow rate value and for producing a difference signal whose magnitude represents the difference between the compared values; and
produce control signals for application to the actuator to cause it to move the throttling element to thereby vary the flow rate to more closely match the stored flow rate value and reduce the magnitude of the difference signal.

28. The electrically actuated valve of claim 23, further comprising a power system for powering one or more of said valve actuator, said sensor, said communication system, and said controller, wherein the instantaneous power drawn from said power system does not exceed 3 Watts.

29. The electrically actuated valve of claim 23, further comprising an enclosure configured to protect said valve actuator, said sensor, said communication system, and said controller in hazardous locations requiring Class I, Division 1 rated equipment.

30. The electrically actuated valve of claim 23, wherein said processor is configured to receive program instructions operable to perform control functions comprising one or more of pressure regulation, flow control, level control, and plunger lift control.

31. The electrically actuated valve of claim 23, wherein said status information comprises one or more of a predicted time of malfunction, an identity of a part, an identity of a preventative or remedial service, and a schedule identifying a period of reduced functionality until service or maintenance can be provided.

32. The electrically actuated valve of claim 23, wherein said communication system comprises a wireless transceiver for receiving configuration information and transmitting status information wirelessly.

33. The electrically actuated valve of claim 23, wherein said communications system comprises a wired transceiver for receiving configuration information and transmitting status information over a wired connection.
